(19) United States
(12) Patent Application Publication
(10) Pub. No.: US 2002/0049594 A1
(43) Pub. Date: Apr. 25, 2002

(54) Speech synthesis

(76) Inventors: Roger Kenneth Moore, Worcester (GB); Wendy Jane Holmes, Worcester (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/870,043

(22) Filed: May 29, 2001

(30) Foreign Application Priority Data
May 30, 2000 (GB) GB 0013241.5

(51) Int. Cl. G10L 13/00

(52) U.S. Cl. 704/258

(57) ABSTRACT

There is disclosed a method and apparatus for providing signals for a synthetic voice by way of derived voice-representative data. In embodiments of the invention, the derived data is derived by combination of data representative of first and second (and maybe more) voices of a base repertoire, the combined data including selected parameters of a formant-type voice synthesiser. Combination may take place by interpolation between or extrapolation beyond the voices of the base repertoire. Individual parameters within the derived data may contain different proportions of corresponding parameters of the base repertoire. The invention is applicable either directly to control parameters of a synthesiser or to tables for these parameters.

This invention relates to speech synthesis. That is to say, it relates to producing signals that are comprehensible as speech by a human listener.

Synthetic production of speech by voice synthesis is of growing technological and commercial interest and importance. Voice synthesis has application in computer/human interfaces, in text-to-speech conversion, and in other applications. It is desirable that synthetic speech should be intelligible, and, in most applications, natural. Synthetic speech that is “natural” in sound gives the impression to a listener of actual human speech.

Early study and development in synthetic speech production had what can perhaps be fairly viewed as a highly theoretical basis. Its aim was to define a manageable number of readily controllable acoustic parameters and to devise rules for such control to result in intelligible speech. From the 1960's into the 1980's significant advances were made, including seminal work on so-called formant synthesizers operative relative to a small number of parameters (which need not exceed twelve, and may be ten or fewer) and related control rules involving a manageable number of carefully selected and analysed phonetic elements and modifiers. A useful general summary of parametric, typically formant-based, speech synthesis appears in the 1987 paper “Text-to-Speech Conversion” by Dennis H Klatt in the Journal of the Acoustical Society of America Vol. 82 No 3.

Developments of this approach, particularly for parallel-formant synthesizers, reached very high levels of sophistication in terms of achieving high intelligibility along with inherent capability for different synthetic voices and coping with different speaking rates etc. Relevant published references include the paper “Speech Synthesis by Rule” by Holmes, Mattingly and Shearme in Language and Speech, 7, 127-143 (1964), Research Report No 1017 from the Joint Speech Research United entitled “Formant Synthesisers: Cascade or Parallel” by J. N. Holmes, and the paper “Copy Synthesis of Female Speech using the JSRU Parallel Formant Synthesizer” by Wendy Holmes for European Conference on Speech Communication and Technology, Paris, September 1989 (pp 513-516). However, while the resulting speech produced purely by rules was intelligible, it did not sound natural; to a typical human listener, it sounds rather artificial and somewhat machine-like.

It was demonstrated by J. N. Holmes in the 1970's that one particularly acclaimed parallel-formant synthesizer (at the time, implemented in hardware) could have its control parameters set up relative to particular actual human voice utterances so that synthesizer output is a nearly indistinguishable reproduction of an original actual human voice utterance. An immediate effect of this demonstration was to focus development attention on refining the rules for synthesis, seeking to achieve more fully the demonstrated potential of the synthesizer as such, if its control parameters could be better selected or defined. Another effect was to encourage alternative effective realisation of such proven analogue hardware type synthesizer in software so as to facilitate further detailed development work by computer programming, as is now the norm.

Latterly, and particularly with increasing availability of large capacity digital computer memory at ever lower cost, development attention and commercial applications have become focused on another approach generally typified as nonparametric. This approach is based on highly detailed fragmenting of actual waveform content of some particular human voice and related concatenation techniques. The paper “Pitch-Synchronous Waveform Processing Techniques for Text-to-Speech Synthesis using Diphones” by Eric Moulines and Francis Charpentier, Speech Communication 9 (1990) North-Holland, gives a useful over-view of methods of waveform concatenation speech synthesis, including time-domain, linear-predictive and frequency-domain approaches to pitch-synchronous overlap and add (PSOLA) techniques. Synthetic speech resulting from such non-parametric waveform concatenation sounds reasonably natural. However, the amount of analysis and data required is prodigious, and it is rare to find more than a very few voices available for any particular system available commercially. These can become boring in general usage, and are not able to satisfy natural customers' wishes for individuality. The present inventors are of the view that the limitations of present technology are such that another approach is more likely to give rise to a speech synthesis system that is capable of production of a wide range of natural-sounding voices.

It is an aim of this invention to contribute to satisfying the demand for a versatile and natural-sounding voice synthesis system by exploiting the flexibility of a formant-type synthesiser in providing a speech synthesis apparatus and method that is capable of producing speech signals that represent a range of different voice characteristics of high intelligibility and of natural sound.

This invention arises from experimentation with two different synthetic voices derived by application of analysis in accordance with a variable parallel formant synthesizer system to reproducing recordings of the same utterance by two actual human voices, initially one male and the other female. Surprisingly, for the same recorded utterance, it was found to be possible to perform a transition or morphing from one synthetic voice to the other on quite a gradual basis with neither significant loss of intelligibility nor much if any intrusion in the way of perceived artificiality. Indeed, it was found that good results came from orderly transition in which analysed parameters, specifically their related data values, could be subject to substantially linear translation between their values for the two different synthetic voices, and even for continuing the substantially linear changes of values to some extent beyond the actual individual voice values.

From consideration of this exercise in successfully achieving voice morphing, new conceptions were formed as to the possibilities for selecting viable variant synthetic voices by interpolation along or extrapolation beyond such transition or translation, on the basis of selecting more desirable or acceptable variants or rejecting less desirable or acceptable variants. These new conceptions give rise to aspects of this invention, as will be defined below.

From a first aspect, the invention provides a method of providing signals for a synthetic voice by way of derived voice-representative data, in which the derived data is derived by combination of data representative of first and second voices, the combined data including selected parameters of a formant-type voice synthesiser.

By varying the particular combination of the first and second voice characteristics, the synthesised voice can likewise be varied as required.

Most typically, a method embodying the invention is applicable where the synthesiser is a synthesis-by-rule (SbR) system, a frame-by-frame copy system, or any of a wide range of other types of system.

Most typically, each of the first and second stored data and the derived data includes a plurality of parameters. In such cases, the combination includes interpolation or extrapolation of one or more parameters of the first and second stored data. The parameters may be interpolated or extrapolated equally or to different extents.

More specifically, in embodiments of the invention, a plurality of parameters may be derived by interpolation or extrapolation of corresponding parameters of a plurality of voices, the ratio of interpolation or extrapolation being different for different parameters. It has been found that there is significant, but not total, freedom to vary the contribution of the different voices to each parameter. For example, the derived data may include a first parameter of value that corresponds to 100% of a first voice and 0% of a second voice, and a second parameter that corresponds to 75% of the first voice and 25% of the second voice. As another example, the derived data may include a first parameter of value that corresponds to 75% of a first voice and 25% of a second voice, and a second parameter that corresponds to 50% of the first voice and 50% of the second voice. (Note that the above figures are approximate, and are given by way of example only.) Other combinations will also give rise to acceptable-sounding output. There are many combinations of parameters that will give rise to an acceptable output, however, this is not without limit. For example, it is likely that derived data that includes a first parameter of value that corresponds to 100% of a corresponding parameter of a first voice and 0% and a second parameter that corresponds to 0% of the first voice and 100% of the second voice will not produce an acceptable result for many of the parameters (although this is not an absolute rule). Experimentation with any particular embodiment can be employed to determine an acceptable region within a parameter space.

From a second aspect, the invention provides a method of generating a set of parameters as a voice characterisation for a formant-type voice synthesiser comprising generating a first set of a parameters from a first voice model having first characteristics, generating a second set of a parameters from a second voice model having second characteristics, and deriving a set of parameters by combining parameters generated by the first and second (and optionally additional) voice models.

In such a method, combining the first and second voice models may be achieved by interpolation or extrapolation. In some circumstances, advantage may be gained if the contribution of each of the first and the second voice models to the combination is variable. This can allow the method to produce a voice with characteristics that vary. Typically, the first and second models have characteristics that differ in many possible ways. As a simplest example, the voices may be just two differently-sounding voices (e.g. having the same gender, accent, age), or voice of different rates, styles or emotions. The above characteristics may be applied between two speakers, or between two different speaking voices of one speaker. The voices may also differ in respect of one or more of the following: gender of a speaker, accent of a speaker or age of a speaker. The above-mentioned combinations are given only by way of example; this is not an exhaustive list.

In many embodiments, the voice synthesiser is controlled using a table-driven synthesis by rule system, the parameter set being derived by combination of values obtained from a plurality of parameter tables. In such cases, the parameters are most commonly used to control the output of a signal generation stage of a speech synthesiser. These parameters (and the output of the system) are typically generated periodically, for example, once during each of a sequence of consecutive time frames.

This invention further provides a method of text-to-speech conversion including speech synthesis by a method according to the previous method aspects of the invention.

Note that it is possible to use a formant synthesiser to generate speech from control parameters, and, alternatively, to use ‘synthesis by rule’ (applied to tables) to generate the control parameters for the formant synthesiser. The parameter modifications proposed by this invention is applicable either to the control parameters directly or to table values for these parameters.

From a third aspect, the invention provides a formant-based speech synthesiser operative according to the first or second aspect of the invention.

Such a synthesiser may be a formant-based speech synthesiser having an input stage, a parameter generation stage, and an output stage, the input stage receiving speech input instructions, the parameter generation stage generating parameters for reproduction by the output stage to generate speech signals, the parameter generation stage being provided with a characterisation table for characterising the output speech signals, wherein the synthesiser further comprises a table derivation stage for deriving the characterisation table by combining data from a plurality of tables that each represent a particular voice.

Typically, the table derivation stage may be implemented as a component of a software system.

Implementing aspects of invention can be done by analysis for each of two or more different actual voice recordings of the same utterance to determine synthesizer control parameters for the synthesizer to copy each one individually. Preferably, such parameters enable the synthesiser to mimic the actual voice as closely as possible. It is convenient to refer to this procedure as “analysis-synthesis”. Determination of the synthesizer control parameters will, for each utterance recording, be implemented as successive time-spaced sets of parameter values. These samples can be considered to be samples produced on a frame-by-frame basis resulting from suitable sampling. By using dynamic programming, it is possible to take account of considerable ranges of differences as to overall and medial timings of the different voices for the same utterance, say by reference to selected phonetic elements of particular relevance or importance to the rules of synthesis for the synthesizer concerned.

There are practical applications where the number of utterances involved is a known closed set. The entire set of utterances is thus readily analysable. The availability of variant synthetic voices from interpolation and extrapolation by the first and second aspects of this invention is correspondingly valuable. This is further the case where extension is investigated to establish viability of other than interpolation within and extrapolation beyond substantially linear translation between analysis-synthesis results for all synthesizer parameters collectively, including viable ranges of relative variations of values of parameters individually and/or in groups compared with a substantially all-linear paradigm. Results can be seen as usefully more generalised method and means aspects of invention involving significant extension from substantially linear interpolation and extrapolation.

Moreover, such extension and generalisation is not seen as exhausting even known capabilities of at least the best of parametric formant-based voice synthesis by rule. Thus, at least where analysis-synthesis is carried out relative to one or more recorded utterances of the same actual voice, and covering substantially the full ranges of the phonetic elements and rules of synthesis concerned, it is established that virtually any other desired utterance can be produced by the synthesizer and sound reasonably natural to the actual voice analysed. Specifically, this type of “copy synthesis” procedure can result in usually less than exact but satisfactorily recognisable and more than acceptable synthesis relative to each of two or more particular actual human voices used as what it is convenient herein to call “sources”, i.e. for the envisaged substantially linear and extended interpolation/extrapolation hereof.

Accordingly, the new conceptions hereof are yet further developed to aspects of invention contributing much greater variety to available synthetic voices, and thus to achieving the ultimate desideratum of acceptably natural sounding intelligible text-tospeech synthesis.

Having established such full data for two or more actual human voices as sources, other acceptable synthetic voices are found by varying such full data from one source towards the full data for another source.

Indeed, specific selections of particular such variant synthetic voices can be made with a sufficiency of difference and individuality to satisfy customers' wishes to have synthesized voices that can be dedicated to them on a one-to-one basis. Accordingly, such an individual synthetic voice as a product made available as a matter of choice or design for a customer gives rise to more specific method and means aspects of this invention.

Amongst matters under further detailed investigation are differences and similarities of source voices as to accents, where regional variations can be profound, and styles of delivery from informal conversational to more formal rhetorical or even oratorical. For the time being, it is recommended for likely highest population of viable synthetic voices by substantially linear or extended interpolation or extrapolation hereof that source voices be of reasonably similar accent and style of delivery. At least the envisaged viable extension of substantially linear transition/translations of values of parameters will include into regions of values bounded by substantially linear transitions between three or more sources. Accordingly, such regions and extensions thereof are seen as prime candidates for containing viable synthetic voices.

As far as other parametric voice/speech synthesizers are concerned application of the substantially linear and extended interpolation and extrapolation hereof should produce resulting new synthetic voices of like viability to the synthesizer concerned, i.e. whereby they reflect characteristics of that synthesizer.

### BRIEF DESCRIPTION OF DRAWINGS

Embodiments of the invention will now be described in detail, by way of example, and with reference to the accompanying drawings, in which:

FIG. 1 is a block diagram for conventional prior systems of text-to-speech synthesis;

FIG. 2 is a block diagram showing additional features for a preferred embodiment of this invention;

FIG. 3 is a block diagram of a parallel formant synthesizer useful for preferred embodiments of this invention;

FIG. 4 is a block diagram concerning production of new sets of voice synthesis data from an initial set; and

FIG. 5 is an outline diagram of relevance to selecting viable new synthetic voices.

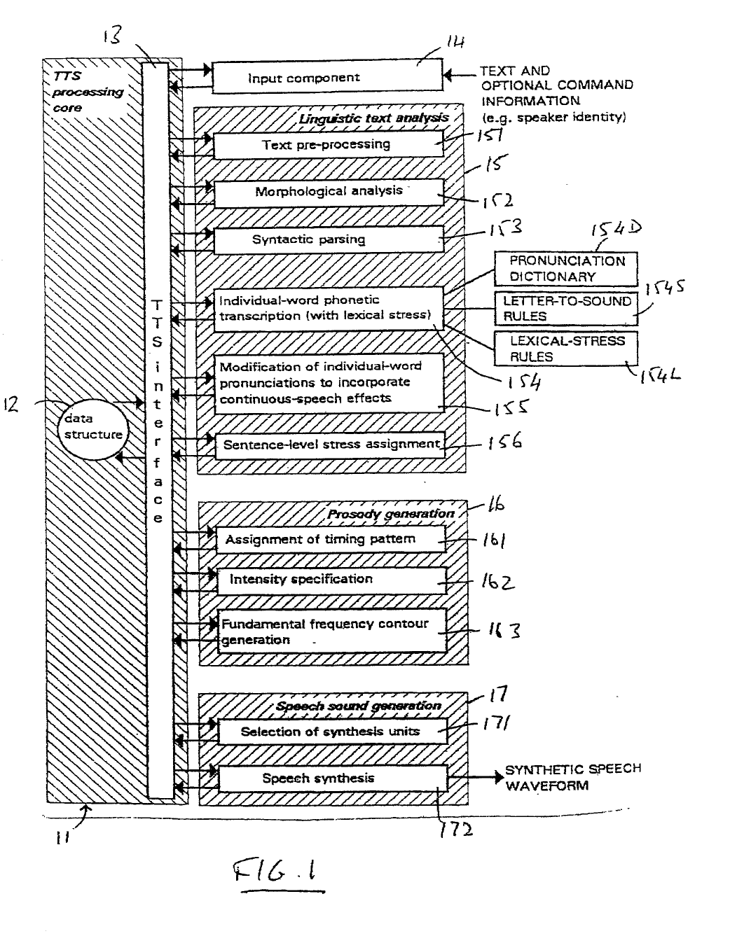

In FIG. 1, the structure of a typical, modular text-to-speech system is shown. The architecture includes a program-controlled data processing core 11 indicated operative to process a suitable data structure 12 and with interface 13 to further blocks representing specific text-to-speech functions. All of these blocks can exchange data bi-directionally with the data processing core 11. These further blocks comprise an input component 14 for text and other operational command information, a linguistic text analysis stage 15, a prosody generation stage 16, and a speech sound generation stage 17.

The linguistic text analysis stage 15 includes various component function modules, namely a text pre-processing module 151; a morphological analysis module 152; a syntactic parsing module 153; an individual-word phonetic transcription module 154; a modification stage 155 that modifies individual-word pronunciations to incorporate continuous speech effects; and a sentence-level stress assignment stage 156. The transcription module 154, in this example, includes a pronunciation dictionary 154D, letter-to-sound rules 154S and lexical stress rules 154L. The prosody generation stage 16 includes component function modules, namely an assignment of timing pattern module 161, an intensity specification module 162, and a fundamental frequency contour generation module 163. The speech sound generation stage 17 incorporates a function module for selection of synthesis units 171 and a speech synthesis module 172 for output of resulting synthetic speech waveforms.

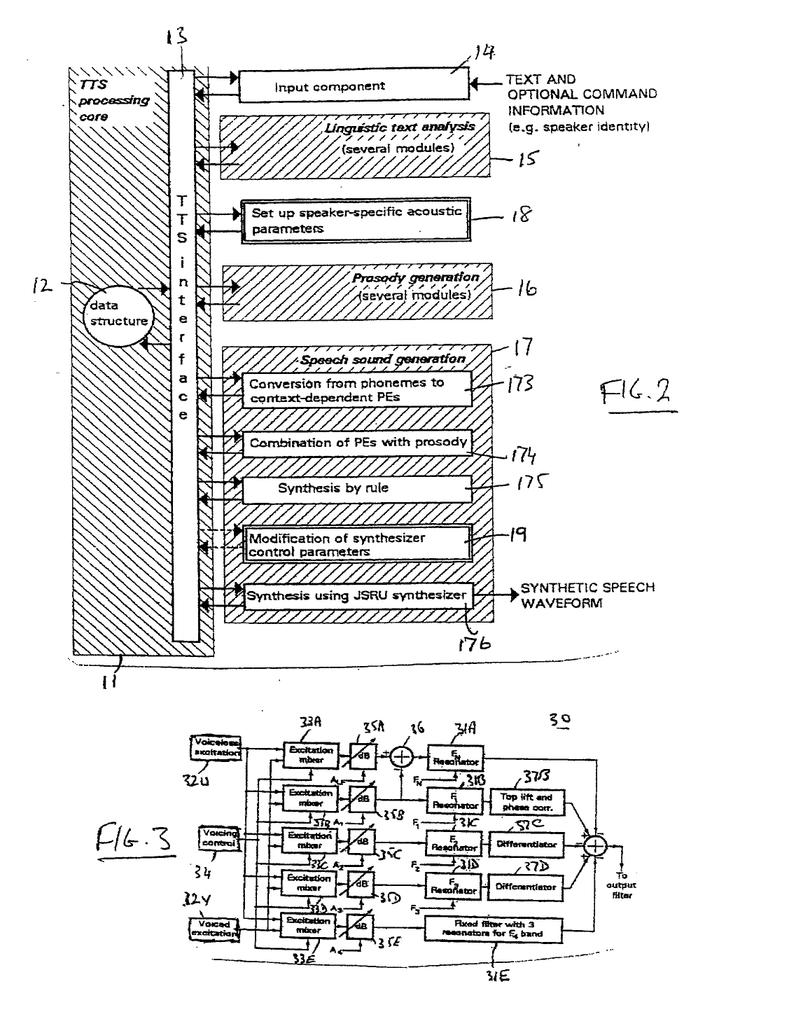

In FIG. 2, the structure of a modular text-to-speech system, being an embodiment of the invention, is shown. This can be considered to be a modification of the architecture of FIG. 1. The architecture of FIG. 2 is a table-driven parametric synthesis-by-rule system operative in conjunction with a particular parallel formant synthesizer to be described and specified with reference to FIG. 3. This is just an example; it is not intended to limit application of this invention against using other parametric formant synthesiser, whether of parallel or cascade, combined or other type.

This embodiment includes an input component 14, a linguistic text analysis stage 15, a and a prosody generation stage 16 as described above. In this embodiment, the speech sound generation stage 17 includes a conversion module 173 for converting from phonemes to context dependent phonetic elements, a combination module 174 for combination of phonetic elements with prosody, a synthesis by rule module 175, and a synthetic speech waveform production module 176 that operates by parallel formant synthesis.

The system of FIG. 2 includes two further stages, as compared with the system of FIG. 1. These stages are, namely, a parameter set-up stage 18 for setting up of speaker-specific acoustic parameters, and a control parameter modification stage 19 for modification of synthesizer control parameters 19.

The term “speaker-specific” is to be taken as synonymous with synthetic voice selection.

These additional stages 18 and 19 permit characterisation of the output of the synthesiser to produce various synthetic voices, particularly deriving for each synthetic voice an individual set of tables for use in generating an utterance according to requirements specified at the input 14.

Typically, there will be multiple sets of tables, each representative of an actual recorded voice, for copy-synthesis purposes, as a basic choice of synthetic voice going beyond mere reproduction of specific perceived utterance or piece of text. The parameter set-up stage 18 can (and preferably does for general implementation) include further functional provision for interpolating between such multiple versions. It may also be operative to change characteristics of the output of the synthesiser with the passage of time, or as a function of time.

The particular parallel formant synthesizer shown in outline block diagram form at 30 in FIG. 3 is modelled in principle on speech output being from time-varying filtering driven by a substantially separable excitation function. It corresponds closely with the above-mentioned highly acclaimed designs by J. N. Holmes, and developments thereof.

A filtering stage 30 is shown as a five-way parallel network of resonators 31A-E for shaping an excitation spectrum to model both vocal tract response and variation of the spectral envelope of the excitation. Voiced and unvoiced excitation generators 32V and 32U produce spectral envelopes that are substantially flat over the frequency range of the formants. Outputs of the excitation generators 32V and 32U are shown applied to excitation mixers 33A-E controlled as to ratio of voiced and unvoiced output content by output of voicing control 34 determining the degree of voicing. Outputs of the excitation mixers 32A-E are shown subjected to individual amplitude control at 35A-E according to control signals on control lines ALF and A1-4, respectively.

The amplitude-controlled outputs of the excitation mixers 33B-D are shown applied to the resonators 31B-D which have control over the output frequency corresponding to the first three formant regions F1-F3 respectively for the voicing to be produced. The resonator 31A is important for nasal sounds and has frequency control by parameter input FN to contribute mainly below the first formant region F1. There is, furthermore, a combinative control 36 of the input to the resonator 31A with that for F1 resonator 31B so that the amplitude control ALF dominates the lowest frequency region, usually up to somewhat above the frequency FN, say to 300 Hz for FN at 250 Hz.

The amplitude-controlled output from the other excitation mixer 33E is shown going to another resonator 31E to generate the formant region F4, conveniently represented using multiple fixed resonators, typically three. This contribution is typically above 3 KHz. Spectral weighting of the regions filter stages 31A-E is individually controlled, the stage 31A for nasal contributions being fairly heavily damped for low-pass operation, the stage 31B for the first formant region being shown with top lift and phase corrections 37B, the stages 31C and 31D for the second and third formant regions being shown subjected to differentiation respectively at 37C, D. The spectrally weighted outputs of the regional filters 31A-E are shown combined at 38. Additional filters and associated amplitude controls can be used for frequencies above about 4 KHz if and as desired.

Preferably, in operation for human speech, the voiced and unvoiced or turbulent sources, will be mixed so that the lower formant regions are predominantly voiced and the upper formant regions are predominantly unvoiced. This action can be as individual settings of the mixers 33A-E in conjunction with the degree-of-voicing control 34.

The parallel-formant synthesizer as illustrated in FIG. 3 has twelve basic control parameters, namely fundamental frequency (F0), nasal frequency FN, first three formant frequencies (F1-F3), amplitude controls (ALF and A1-A4), degree of voicing (34) and glottal pulse open/closed ratio. These parameters will be specified at regular intervals, typically 10 milliseconds or less. Often the nasal frequency FN is fixed at 250 Hz and the glottal pulse open/closed ratio is fixed at 1:1, so giving only 10 parameters to specify for each time interval.

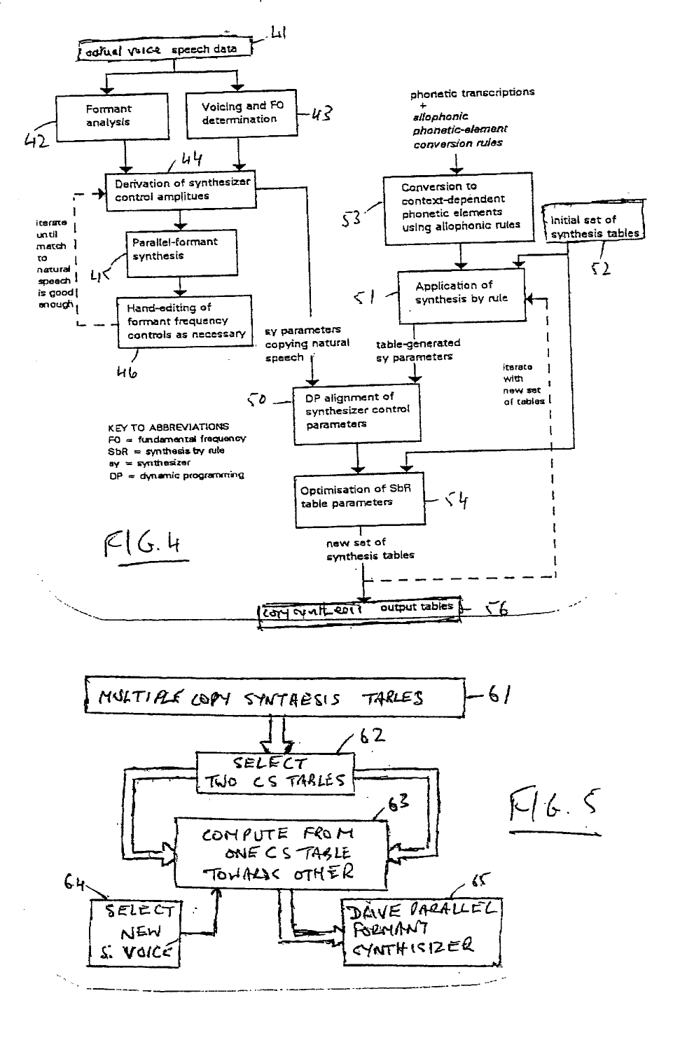

FIG. 4 summarises the creation of data involving tables that include definition of the above parameters for a particular actual human voice as an exercise in analysis-synthesis with a view to enabling copy-synthesis for that voice. This procedure involves study of speech data 41 for analysis of a recording for formants 42 and derivation of appropriate fundamental frequency and degree of voicing 43 (and can also include glottal pulse width and ratio if not set at a fixed value as can be viable) to which synthesizer control amplitudes will be applied 44. The parameter values may be refined iteratively based on the output of a parallel-formant synthesizer 45. This process is typically performed by a software program, although further refinement may be made manually 46.

When matching is good enough, that is to say, when the output of the synthesizer is close enough to the actual human voice concerned, the amplitude control data is co-ordinated 50 with table-generated synthesizer parameters obtained from application of synthesis by rule 51 in relation to an initial set of synthesis tables, 52 and conversion to context-dependent phonetic elements using allophonic rules 53. The coordination 50 will involve dynamic programming and optimisation of synthesis by rule table parameters 54, which may be on an iterative basis, to produce a new set of synthesis tables, which will operate as output tables 56 for satisfactory copy synthesis based on analysis-synthesis matching of analysed natural speech from an actual talker or source. While the details of the method described here are specific to a particular implementation for use with the particular synthesizer and synthesis-by-rule method, the principles apply to any formant synthesizer and method of driving that synthesizer.

Turning to FIG. 5, full data output tables resulting from copy synthesis for at least two actual human voices forms a base repertoire 61. From this base repertoire, the two, or any two, voices are selected 62. The voices may be selected at will, or there may be some limitations, say to two female voices or two male voices or two children's voice to produce, say, a female, a male or a child's voice is required. Alternatively, the voices may be limited to two not too dissimilar original voices of only quite minor individualisation as desired or satisfactory. In fact the selection need not be limited to just two voices.

The data of the selected tables is then processed at step 63 by a programmed digital computer to produce a derived synthesis table which can be used to derive the output for the formant synthesiser. The process by which the derived synthesis table is generated can include a variety of procedural steps and operations. As a first example, the process may involve generating data for the derived table in terms of reducing differences between relevant corresponding data items in tables of the base repertoire, including the synthesizer parameters and quantified other rule-based differences. As a collective gradual substantially linear process, output voice morphing would be obtained. By including appropriate steps in the process, many particular desired new synthetic voices could be obtained by generating an appropriate derived table. Typically, the tables in the base repertoire and the derived table will have the same underlying structure.

As illustrated, a “live” selection of a desired output is feasible 64 on an auditioning basis, that is to say, that is to say, by an iterative process of driving a parallel-formant synthesizer at 65, listening to the output produced, changing the derived table accordingly, listening to the output again, and so on. As envisaged, a repertoire of two, three or more copy-syntheses of actual human voices, (perhaps, limited to the condition that these are categorised as of being not too dissimilar in accents, delivery or some other condition) can be predisposed to cover parameter values in regions within and (perhaps to a limited extent) beyond a parameter space defined between these voices.

It is not, in practice, necessary in order to achieve satisfactory synthetic voices, to vary all of the parameters collectively or linearly, nor to limit the range of variation. However, experiment may show that there are preferred selections of parameters, limits therefor, groupings and correlations do emerge in relation to satisfactory variant synthetic voices and actual source voices.

In typical embodiments, the derived table is produced by interpolation or extrapolation. Interpolation and extrapolation can be achieved straightforwardly by systematic linear combination of some or all synthesiser control parameters (ten in the case using the parallel-formant synthesiser shown in FIG. 3, including three formant frequencies F1, F2, F3; three formant amplitudes A1, A2, A3, amplitude in low-frequency region ALF; amplitude in high-frequency region AHF; degree of voicing, V; fundamental frequency F0) from the tables in the base repertoire. It is also possible to apply interpolation or extrapolation to any timing differences. For example, if speech sound has an associated duration for both tables, a new duration can be obtained by interpolating or extrapolating these two durations.

It has been found that some parameters are more influential than others in affecting voice quality, and therefore the processing of those parameters in producing the derived table has a comparatively greater influence on the speech synthesiser output. Which parameters have the most influence depends on the difference between the different samples that are contributing to the interpolation but in general F0 and the formant frequencies are the most important. F0 is particularly important for the male-female distinction and for certain emotional qualities. Amplitudes are more relevant when interpolating between certain emotions than between speakers for example. The above finding implies that it is possible to change voice characteristics, or generate a new voice, by changing as few as two or three parameters. Further routine experimentation may reveal further significant findings.

Informal experiments on interpolating and switching just selected formant synthesiser control parameters have been carried out both for male-female interpolation and for interpolating between “soft” and “strident” utterances for a single speaker. In both cases the main findings were as follows:

1. F0 has the single greatest effect and it seems necessary to modify this to get the relevant percept (i.e. modifying all other parameters except F0 has a much smaller effect that just modifying F0—at least for the cases that the inventors have looked at).

2. F1 and F2 are important to obtain a realistic percept of the relevant quality.

3. Also modifying A1 and A2 helps further—especially when there are marked amplitude differences, as in the soft/strident example.

4. F3 has some effect, but minor.

5. Other parameters have comparatively little effect. Duration seems to have very little effect in these tests, but in certain cases will be relevant—e.g. if interpolating on speaking rate. The voicing parameter (V) has no influence in most cases, but would be relevant if trying to interpolate from (or extrapolate beyond) whispered speech to normal speech.

It is possible to interpolate between substantially any number of different adult voices (male and female) and obtain a new voice that sounds believable as being from a real person.

It is also possible to extrapolate beyond one voice, in a direction dictated by (e.g. opposite to) another voice. For example, if interpolating between a male and a female speaker, extrapolation can give either an extremely deep male voice or a very child-like female voice. Whereas for interpolation the source speakers provide realistic bounds for the parameters, in the case of extrapolation there are limits on the extent to which parameters can be extrapolated. These limits are imposed by the fact that the formant values must be plausible. In practice extrapolation by up to about 50% seems to be possible without generating an unnatural-sounding voice.

Interpolation and extrapolation can also be applied to the generation of soft versus strident voice qualities. Interpolating mid-way between a “soft” and a “strident” parameterisation of a recording gave a voice that was perceived as “normal”. Similarly extrapolation leads to more extreme versions of these qualities. Extrapolation of up to around 50% appears to change the emotional quality of the voice without introducing obvious artefacts.

Interpolation and extrapolation have also been applied to move between a child's voice and an adult's voice. Because the effect of age on the voice is non-linear, it has been found that the method normally works best if it is not attempted across a very wide age span.

It is not necessary that exactly the same interpolation ratio is used for all parameters; there is a certain degree of tolerance. For any case, straightforward experiments can be performed to quantify this but it may be that, for example, F1 and F2 could be 50% speaker 1 and 50% speaker 2, while F3 is 75% speaker 1 and 25% speaker 2 without the speech sounding unnatural.

Although the invention described above has only been described in relation to formant frequencies and amplitudes, fundamental frequency, voicing and timing (duration), it is possible to apply it to other synthesiser control parameters that might be varied to characterise a voice. For example, such parameters might include the shape of the glottal pulse representing the excitation, amongst other possibilities. Moreover, the invention has principally been described with reference to time-aligned pairs of utterances. However, the invention is equally applicable to other representations, such as hidden Markov models of formant synthesiser parameters or, in particular, the synthesis by rule method of Holmes et al. (1964). Furthermore, The invention is applicable either to the control parameters directly or to table for these parameters.

1. A method of providing signals for a synthetic voice by way of derived voice-representative data, in which the derived data is derived by combination of data representative of first and second voices, the combined data including selected parameters of a formant-type voice synthesiser.

2. A method according to claim 1 in which the synthesiser is a synthesis-by-rule (SbR) system.

3. A method according to claim 1 in which each of the first and second stored data and the derived data includes a plurality of parameters.

4. A method according to claim 3 in which the combination includes interpolation or extrapolation of one or more parameters of the first and second stored data.

5. A method according to claim 4 in which various parameters are interpolated or extrapolated to different extents.

6. A method according to claim 4 in which a plurality of parameters are derived by interpolation or extrapolation of corresponding parameters of a plurality of voices, the ratio of interpolation or extrapolation being different for different parameters.

7. A method according to claim 4 in which the derived data includes a first parameter of value that corresponds to 100% of a first voice and 0% of a second voice, and a second parameter that corresponds to 75% of the first voice and 25% of the second voice.

8. A method according to claim 4 in which the derived data includes a first parameter of value that corresponds to 75% of a first voice and 25% of a second voice, and a second parameter that corresponds to 50% of the first voice and 50% of the second voice.

9. A method according to claim 4 in which the derived data includes parameters interpolated or extrapolated within an acceptable region of a parameter space.

10. A method according to claim 1 in which the parameters are control parameters of a formant synthesiser.

11. A method according to claim 1 on which the parameters are table values in a SbR synthesiser.

12. A method of generating a set of parameters as a voice characterisation for a formant-type voice synthesiser comprising generating a first set of parameters from a first voice model having first characteristics, generating a second set of parameters from a second voice model having second characteristics, and deriving a set of parameters by combining parameters generated by the first and second (and optionally additional) voice models.

13. A method according to claim 12 in which combining the first and second voice models is achieved by interpolation or extrapolation.

14. A method according to claim 13 in which the contribution of each of the first and the second voice models to the combination is variable.

15. A method according to claim 12 in which the first and second models have characteristics that differ in respect of one or more of the following: gender of a speaker, accent of a speaker or age of a speaker, emotion of a speaker, rate of speaking and style of speaking.

16. A method according to claim 12 in which the first and second models originate from different speakers.

17. A method according to claim 12 in which the first and second models originate from different speaking voices of one speaker.

18. A method according to claim 12 in which the voice synthesiser is a table-driven synthesiser, the parameter set being derived by combination of values obtained from a plurality of parameter tables.

19. A method according to claim 12 in which the parameters are used to control the output of a signal generation stage of a speech synthesiser.

20. A method according to claim 12 in which the parameters are generated periodically.

21. A method according to claim 20 in which the parameters are generated once in each of a succession of time frames.

22. A method of text-to-speech conversion including speech synthesis by a method according to claim 12.

23. A formant-based speech synthesiser operative according to a method of claim 12.

24. A formant-based speech synthesiser having an input stage, a parameter generation stage, and an output stage, the input stage receiving speech input instructions, the parameter generation stage generating parameters for reproduction by the output stage to generate speech signals, the parameter generation stage being provided with a characterisation table for characterising the output speech signals, wherein the synthesiser further comprises a table derivation stage for deriving the characterisation table by combining data from a plurality of tables that each represent a particular voice.

25. A formant-based speech synthesiser according to claim 24 in which the table derivation stage is implemented as a component of a software system.
